(19) United States
(12) Patent Application Publication
(10) Pub. No.: US 2009/0172824 A1
(43) Pub. Date: Jul. 2, 2009

(54) Corruption of swarm downloads in a decentralized network employing advanced intelligent corruption handling

(75) Inventor: Michael Wayne Colburn, Redwood City, CA (US)

Correspondence Address: PATENT DEPARTMENT;MACROVISION CORPORATION, 2830 DE LA CRUZ BLVD., SANTA CLARA, CA, 95050, US

(73) Assignee: Marcovision Corporation

(21) Appl. No.: 12/005,701

(22) Filed: Dec. 28, 2007

(51) Int. Cl. H04L 9/32; G06F 17/30

(52) U.S. Cl. 726/31; 707/3; 707/E17.107

(57) ABSTRACT

An eMule network employs Advanced Intelligent Corruption Handling (AICH). Agent clients offer copies of a corrupted version of content. When the corrupted copies participate in swarm downloads with uncorrupted copies, the AICH is triggered. The agent clients are sufficient in number to out vote all other clients in a trusted root hash determination performed by the AICH. As a result, one of the agent clients provides a recovery packet used by the AICH to determine good and bad blocks. Since the recovery packet includes block hashes for the corrupted version of the content, blocks uploaded by clients providing uncorrupted versions are determined to be bad blocks and the clients identified as bad sources. The agent clients, on the other hand, either fail to upload a requested block or do so in a manner to discourage a user of the downloading client to wait for completion of the upload.

### FIELD OF THE INVENTION

The present invention generally relates to techniques for deterring unauthorized copying in decentralized networks and in particular, to a method and system for corruption of swarm downloads in a decentralized network employing advanced intelligent corruption handling.

### BACKGROUND OF THE INVENTION

Unauthorized copying in decentralized networks using peer-to-peer (P2P) file sharing has become a major concern to owners of copyrighted material. Unlike a centralized network, decentralization makes it commercially impractical to pursue all copyright violators in court. This is because decentralization requires filing lawsuits against virtually millions of client computer operators instead of only one party operating a central computer.

Accordingly, copyright owners seek other methods for protecting their copyrighted material, such as blocking, diverting or otherwise impairing the unauthorized distribution of their copyrighted works on a publicly accessible decentralized or P2P file sharing network. In order to preserve the legitimate expectations and rights of users of such a network, however, it is desirable that copyright owners do not alter, delete, or otherwise impair the integrity of any computer file or data lawfully residing on the computer of a file trader.

Swarm downloads are particularly efficient for sharing files in a decentralized network. To perform a swarm download, a file to be shared is divided into parts that can be concurrently requested and downloaded from different sources (i.e., other client nodes) in the decentralized network. Downloaded parts may then in turn, be made available to other client nodes so as to increase the number of sources for the part and consequently, speed up overall downloading of the file within the network by all client nodes that are procuring a copy of the file.

One way to deter the unauthorized distribution of protected files in a decentralized network is to corrupt swarm downloads of the file. As an example, a technique for corrupting swarm downloads in a file sharing network is described in commonly owned U.S. patent application Ser. No. 11/052,171 entitled “Corruption and its deterrence in swarm downloads of protected files in a file sharing network,” filed Feb. 7, 2005, which is incorporated by reference.

To recover from inadvertent or intentional corruption of swarm downloads, Intelligent Corruption Handling (ICH) and Advanced Intelligent Corruption Handling (AICH) techniques have been developed for the eMule protocol, which is one type of decentralized network commonly used for file sharing. Additional details on these corruption handling techniques as well as the eMule protocol may be found at http://www.emule-project.net.

### OBJECTS AND SUMMARY OF THE INVENTION

Although swarm downloads are useful for many legitimate file sharing activities, they can also be used unfortunately for unauthorized copying and distribution of protected content (i.e., content that is to be protected against unauthorized copying).

Accordingly, it is an object of one or more aspects of the present invention to provide a method and system for corrupting a swarm download of protected content in a decentralized network.

Another object is to provide such method and system so that the legitimate rights and expectations of users of the network are preserved.

Another object is to provide such method and system such that the network is not prevented from operating for legitimate file sharing activities.

Another object is to provide such method and system so that copies of protected content already residing on the network are not destroyed through erasure or corruption of data.

Still another object is to provide such method and system so as to be capable of corrupting swarm downloads of protected content without such corruption being thwarted by intelligent and advanced intelligent corruption handling techniques.

Yet another object is to provide such method and system so as to be capable of corrupting swarm downloads of protected content while advantageously capitalizing on characteristics of the advanced intelligent corruption handling process to assist in such corrupting activity.

These and additional objects are accomplished by the various aspects of the present invention, wherein briefly stated, one aspect is a method for corrupting swarm downloads in a decentralized network employing advanced intelligent corruption handling, comprising: offering copies of a corrupted version of the protected content for downloading on the decentralized network in such a manner that the copies of the corrupted version participate in swarm downloads with copies of an uncorrupted version of the protected content, and sources of the copies of the corrupted version are sufficient in number so as to effectively out vote sources of the copies of the uncorrupted version in an advanced intelligent corruption handling process performed by a downloading client in the decentralized network.

Another aspect is a system for corrupting swarm downloads in a decentralized network employing advanced intelligent corruption handling, comprising: a plurality of agent clients participating in the decentralized network by offering copies of a corrupted version of the protected content for downloading on the decentralized network in such a manner that the copies of the corrupted version participate in swarm downloads with copies of uncorrupted version of the protected content and the number of the plurality of agent clients is sufficient so as to effectively out vote, as part of an advanced intelligent corruption handling process performed by a downloading client in the decentralized network, file sharing clients offering the copies of the uncorrupted version in the decentralized network.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of an eMule network employing AICH which includes a system for corrupting swarm downloads in the network utilizing aspects of the present invention.

FIGS. 2-4 illustrate a flow diagram of the file sharing and AICH process used in the eMule decentralized network.

FIG. 5 illustrates a flow diagram of a control server portion of a method for corrupting swarm downloads in a decentralized network employing AICH, utilizing aspects of the present invention.

FIG. 6 illustrates a flow diagram of an agent client portion of a method for corrupting swarm downloads in a decentralized network employing AICH, utilizing aspects of the present invention.

### DETAILED DESCRIPTION OF THE PREFERRED EMBODIMENT

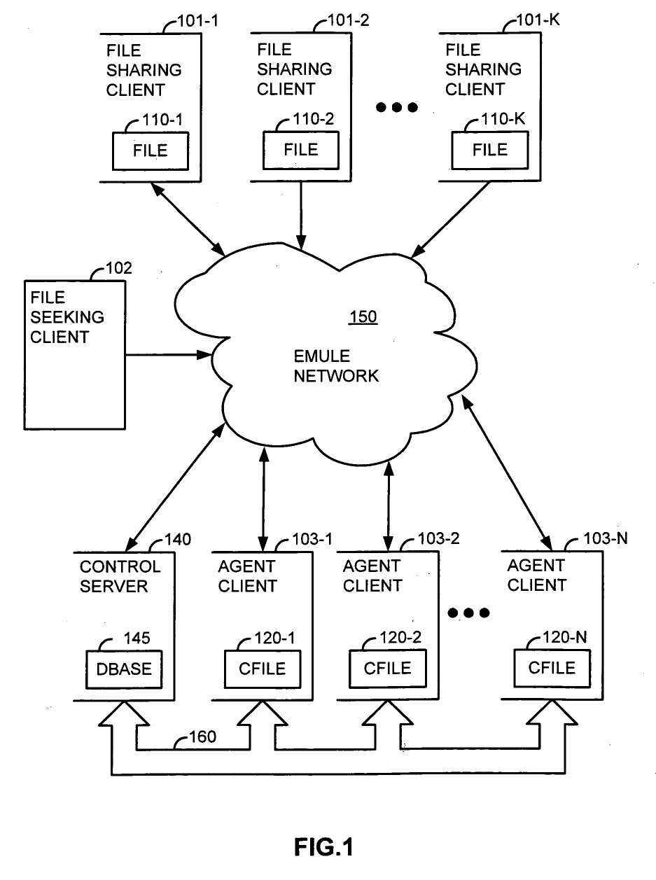

FIG. 1 illustrates, as an example, a block diagram of an eMule decentralized network 150 employing Advanced Intelligent Corruption Handling (AICH). The eMule network 150 is a peer-to-peer file sharing application that connects to both the eDonkey network and the Kad network.

Several clients (e.g., client computers or nodes) participating in the eMule network 150 are shown as being “pulled out” for illustrative purposes. For example, a plurality of file sharing clients, 101-1 to 101-K, is shown which offer content (such as a file) that is be protected against unauthorized distribution (referred to herein as “protected content”) to other clients in the network 150, such as a file seeking client 102 (also referred to herein as the “downloading client”). A plurality of agent clients, 103-1 to 103-N, is also shown which operate in conjunction with a control server 140 to inhibit sharing of the protected content in the eMule network 150.

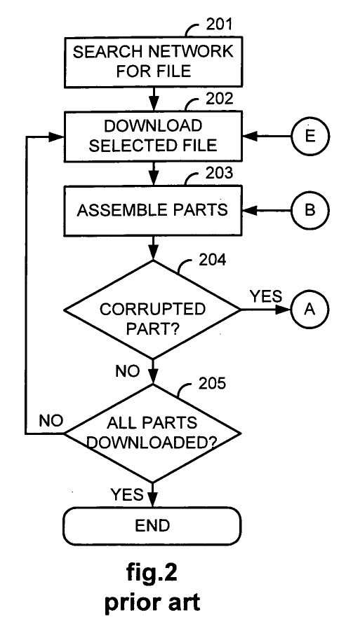

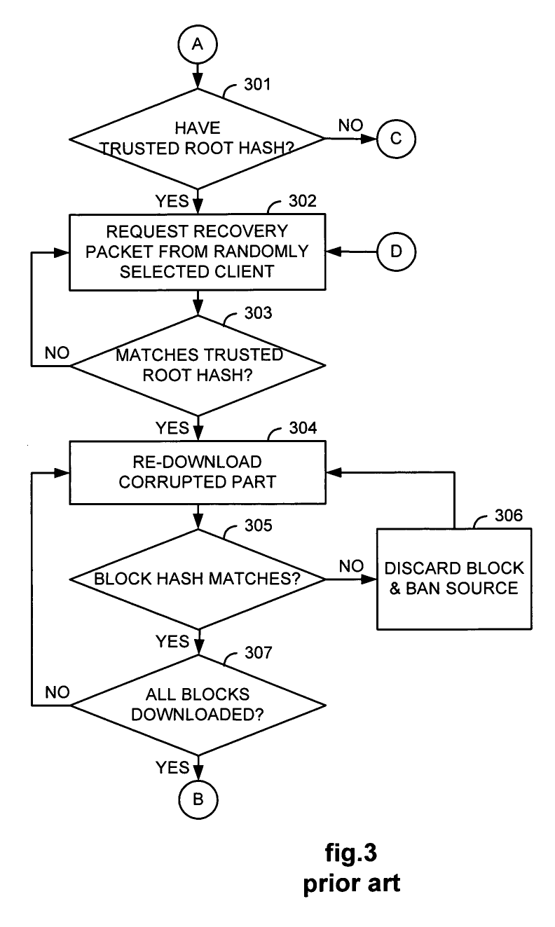

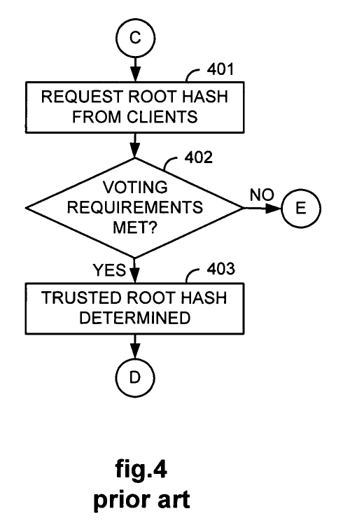

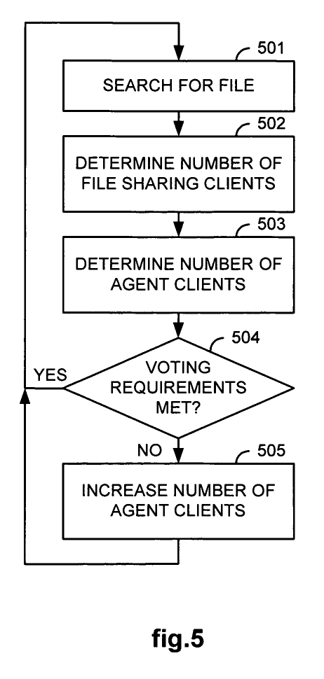

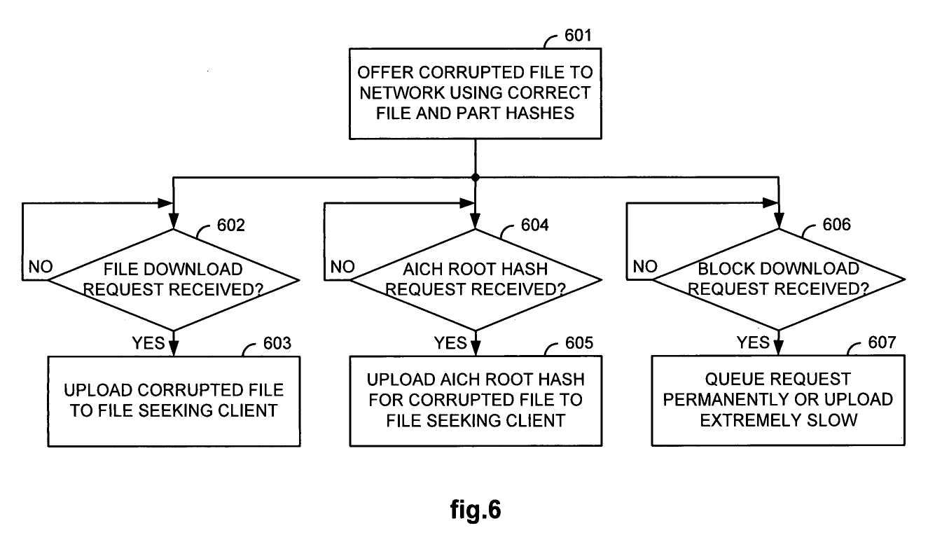

FIGS. 2-4 illustrate, as an example, a flow diagram of the file sharing and AICH process used in the eMule network 150, wherein the general file sharing process performed by an eMule application running on the file seeking client 102 is shown and described in reference to FIG. 2 and the AICH process performed by the eMule application is shown and described in reference to FIGS. 3-4. Although not directly a part of the present invention, descriptions of the eMule file sharing and AICH process are provided herein to better understand the present invention which is performed by the control server 140 and agent clients, 103-1 to 103-N, in conjunction with the eMule file sharing and AICH process as described in reference to FIGS. 5-6.

Referring to FIG. 2, in 201, the eMule application running on the file seeking client 102 searches the eMule network 150 for a file desired by its user. Each file that is shared using eMule is hashed using the MD4 algorithm. The top-level MD4 hash (referred to herein as the “file hash”), along with the file size, filename, and several secondary search attributes such as bit rate and codec are stored on eD2k servers and the serverless Kad network. A user of the file seeking client 102 can thus search (using the eMule application running on the file seeking client 102) a desired file in the eD2k servers and Kad network, and receive back a list of files matching the search query along with the IP/port addresses of the clients offering those files for download on the eMule network 150.

In the present example, there are two types of clients offering the desired file for downloading in the eMule network 150. First, there are the file sharing clients, 101-1 to 101-K, which offer uncorrupted copies (FILE), 110-1 to 110-K, of the desired file for downloading. This first group of clients represents the normal participants of the network 150. Second, there are the agent clients, 103-1 to 103-N, which offer corrupted copies (CFILE), 120-1 to 120-N, of the desired file-for downloading. This second group of clients, along with the control server 140, is part of a system for corrupting swarm downloads in the network 150.

The file seeking client 102 does not know in this case that the copies (CFILE), 120-1 to 120-N, being offered by the agent clients, 103-1 to 103-N, are corrupted (or otherwise different than the uncorrupted version of the file), because the agent clients, 103-1 to 103-N, identify these copies in their search response using the same file hash that the file sharing clients, 101-1 to 101-K, use to identify their copies, 110-1 to 110-K. Note that as used herein, the term “corrupted” indicates a file containing different data than the desired file (i.e., protected content), so as to trigger the AICH process.

In 202, the user of the file seeking client 102 selects one of the files on the list received in 201 through the eMule application running on the file seeking client 102, and the eMule application contacts the client offering that file as well as other clients offering to share files with the same file hash by establishing peer-to-peer connections with them using the IP/ports addresses provided along with the list, and downloads the desired file from these clients using a swarm download of the file.

In 203 and 204, each part (e.g., 9.28 MB chunk) of the file is assembled and its hash value calculated to confirm successful transmission. In order to perform such part confirmation, a hash set (which includes hashes for all parts of the file) is provided along with the file hash from the eD2k servers and Kad network. If a part is found to be corrupted in 204 (i.e., its computed hash fails to match the corresponding part hash), then the eMule application proceeds to the AICH process (as indicated by the circled letter “A” which serves as an entry point into the AICH process as shown in FIG. 3).

On the other hand, if it is determined in 204 that the assembled part is not corrupted (i.e., its computed hash matches the corresponding part hash), then in 205, a determination is made whether all parts of the file have been downloaded. If the determination in 205 is NO, then the eMule application loops through 202-205 until a YES determination results in 205, at which point, the download of the file is completed and the process terminates.

FIG. 3 illustrates, as an example, the AICH process performed by the eMule application running on the file seeking client 102 after a corrupted part has been detected in 204 of FIG. 2. As part of the AICH process, each part is divided into 180 KB blocks, resulting in 53 blocks per each part. For each block, a hash value (referred to herein as a “block hash”) is calculated using the SHAI hash algorithm.

In 301, a determination is first made whether a trusted root hash is available. The trusted root hash is not to be confused in this case with the file hash, which was computed from the part hashes using the MD4 algorithm. The root hash is a different calculation based upon the block hashes of the AICH hash set.

If the trusted root hash is not already available, then it may be determined by an AICH voting process described in reference to FIG. 4 (as indicated by the circled letter “C” which serves as an entry point into the AICH trusted root hash voting process). As will be described in reference to FIGS. 5, 6, the present invention takes advantage of the AICH voting process to fool the eMule application into determining that the corrupted data that the agent clients, 103-1 to 103-N, send to it is “good data” and the uncorrupted data that is transmitted by the file sharing clients, 101-1 to 101-K, is “bad data”.

Once a trusted root hash is determined to be available in 301, then in 302, the AICH process randomly requests a recovery packet including a complete AICH hash set from one the clients offering to share the desired file in the eMule network 150. In 303, a determination is made whether verifying hashes in the recovery packet result in a match with the trusted root hash. If the determination in 303 is NO, then the AICH process loops back to 302 to request a recovery packet from another one of the client computers. On the other hand, if the determination in 303 is YES, then the recovery packet is verified as being legitimate and the AICH process continues to 304 where it starts to re-download the file part that was previously determined to be corrupted in 204 of FIG. 2.

In 305, a hash is calculated by the AICH process for each downloaded block and matched against the corresponding block hash in the recovery packet. If the two hashes match, then the AICH process determines that the downloaded block is “good data” and proceeds to 307 where a determination is made whether all the blocks of the re-downloaded part have been downloaded. If more blocks still need to be downloaded, then the determination in 307 is NO and the AICH process loops back through 304-307 until all blocks have been successfully downloaded. On the other hand, if the two hashes do not match in 305, then the AICH process determines that the downloaded block is “bad data” and proceeds to 306 where the bad block of data is discarded and the source of the “bad data” is discredited as being a “bad source” and added to a “bad source list” so that it is treated as a “dead” IP address and thus banned for a period of time according to the eMule protocol. The AICH process then loops back through 304-307 to continue to re-download the corrupted part until all blocks of the part have been successfully downloaded.

FIG. 4 illustrates, as an example, the voting process performed by the AICH process to determine a trusted root hash. In 401, the AICH process requests a root hash from each client offering the desired file for downloading. Note, however, that this request is not necessary, and therefore need not be performed, if root hashes have already been provided by each of these clients at an earlier stage in the file sharing process such as in 201 or 202 in FIG. 2. In 402, the AICH process determines whether two voting requirements are satisfied to determine a winning root hash. First, at least ten (10) clients must send the same root hash value. Second, at least ninety-two percent (92%) of all clients responding agree on a hash value.

If the determination in 402 is NO (i.e., the voting requirements are not met), then the AICH cannot proceed and therefore, the eMule file sharing process loops back to 202 of FIG. 2 (as indicated by the circled letter “E” which serves as a re-entry point into the file sharing process) to try to re-download the desired file without encountering a corrupted part. In accordance with the present invention, however, the likelihood of success in this case is very small, because of the large percentage of agent clients, 103-1 to 103-N, in the network 150 which are providing copies of a corrupted version of the desired file.

On the other hand, if the determination in 402 is YES (i.e., the voting requirements are met), then in 403, the root hash provided by a group of clients meeting the voting requirements is determined to be the trusted root hash, and the AICH process continues by proceeding to 302 of FIG. 3 (as indicated by the circled letter “D” which serves as a re-entry point into the AICH recovery process).

As will be explained further below, a key aspect of the present invention is to not only ensure that the agent clients, 103-1 to 103-N, meet the voting requirements in 402, but also that a root hash provided by the agent clients, 103-1 to 103-N, is selected as the trusted root hash in the process described in reference to FIG. 4.

FIG. 5 illustrates, as an example, a flow diagram of a first part, which is performed by the control server 140, of a method for corrupting swarm downloads in the eMule network 150. In this first part, the control server 140 operates to ensure that the agent clients, 103-1 to 103-N, whose participation in the network 150, shared files and associated hash information are controlled by the control server 140 (or an entity controlling the control server 140) are sufficient in number to successfully out vote the file sharing clients, 101-1 to 101-K, in a trusted root hash determination as described in reference to FIG. 4.

In 501, an eMule application running on the control server 140 is employed to search the network 150 for a file to be protected in the same manner as described in reference to 201 of FIG. 2. A database 145 in the control server 140 stores information for this file as well as other files to be protected. The search in this case may be initiated by a user of the control server 140, or performed automatically as part of a monitoring procedure performed by a monitoring application running on the control server 140.

After receiving the search results back, in 502 and 503, the number of file sharing clients, 101-1 to 101-K, and the number of agent clients, 103-1 to 103-N, are respectively determined by a special application running on the control server 140. These determinations may be made from the IP/port addresses of the agent clients, 103-1 to 103-N, that are known by the control server 140, because either the control server 140 activated the agent clients, 103-1 to 103-N, or the control server 140 was informed by another entity of their activation. Unrecognizable IP/port addresses would then be presumed to be those of the file sharing clients, 101-1 to 101-K.

In 504, a determination is made by the special application whether the number of agent clients, 103-1 to 103-N, would statistically be able to out vote the number of file sharing clients, 101-1 to 101-K, in an AICH voting process performed in accordance to the requirements as described in reference to 402 of FIG. 4. In order to meet such requirements, the following relationships between the number of agent clients “N” and the number of file sharing clients “K” should be met:

$$\begin{matrix}N \geq 10 & ( 1 ) \\ \frac{N}{N + K} \geq 0.92 & ( 2 )\end{matrix}$$

If both requirements are met, then the determination in 504 is a YES, and the method loops back to 501 to continue to monitor the eMule network 150 and ensure that the number of agent clients, 103-1 to 103-N, would statistically be able to out vote the number of file sharing clients, 101-1 to 101-K, in an AICH voting process.

On the other hand, if either of the requirements shown as equations (1) and (2) above is not met, then the method proceeds to 505 where the number of agent clients is increased (e.g., by activating more agent clients to offer the protected file for downloading in the network 150) until the requirements shown in equations (1) and (2) are met. The method then loops back to 501 to continue to monitor the eMule network 150 and ensure that the number of agent clients, 103-1 to 103-N, would statistically be able to out vote the number of file sharing clients, 101-1 to 101-K, in an AICH voting process.

FIG. 6 illustrates, as an example, a flow diagram of a second part, performed by each of the agent clients, 103-1 to 103-N, of the method for corrupting swarm downloads in the eMule network 150. In this second part, each of the agent clients, 103-1 to 103-N, operates to not only corrupt the swarm downloads of the protected file, but also to effectively discredit the file sharing clients, 101-1 to 101-K, so as to get them banned and placed on a banned sources list according to the eMule protocol.

In 601, the agent clients, 103-1 to 103-N, offer corrupted versions of the file that is to be protected to other clients on the eMule network 150. In this case, the “activation” of each of the agent clients, 103-1 to 103-N, is performed by the control server 140, which communicates with the agent clients, 103-1 to 103-N, over a closed network 160 such as a local area, wide area or virtual private network, by not only instructing the agent client to offer to share a copy of the protected content to other clients on the eMule network 150, but also providing the agent client with the corrupted version of the protected content and all hash values to be associated with the protected content in communications with the eMule applications and its AICH processes running on file seeking clients in the network 150.

In 602 and 603, when a file download request is received from an eMule application running on a file seeking client in the network 150, an eMule application running on the receiving agent client uploads a copy of the corrupted version of the protected content to the file seeking client. Note that the corrupted copy is expected to trigger the AICH process as described in reference to 204 of FIG. 2.

In 604 and 605, when an AICH root hash request is received from an AICH process running on the file seeking client per 401 of FIG. 4, the eMule application running on the receiving agent client provides a root hash corresponding to the corrupted version of the protected content. Note that this root hash value will differ from that being provided by each of the file sharing clients, 101-1 to 101-K, because their root hash value will be based on the uncorrupted version of the protected content.

Since the control server 140 ensures that the number “N” of agent clients, 103-1 to 103-N, is always sufficient to out vote the number “K” of file sharing clients, 101-1 to 101-K, in the AICH voting process described in reference to FIG. 4, the root hash reported by the agent clients, 103-1 to 103-N, will be determined by the AICH process running on the file seeking client to be the trusted root hash. As a direct consequence of this, only a recovery packet received from one of the agent clients, 103-1 to 103-N, will be determined to be valid per 302-303 of FIG. 3.

Note also, however, that the block hashes included in the recovery packets reported by the agent clients, 103-1 to 103-N, will differ from the block hashes included in the recovery packets reported by the file sharing clients, 101-1 to 101-K, because the block hashes reported by the agent clients, 103-1 to 103-N, are calculated from the corrupted version of the protected content, and the block hashes reported by the file sharing clients, 101-1 to 101-K, are calculated from the uncorrupted version of the protected client.

In 606 and 607, when a re-download request for a part identified as being corrupt per 204 of FIG. 2, is received from an AICH process running on a file seeking client per 304 of FIG. 3, the eMule application running on the receiving agent client either notifies the file seeking client that it is busy and that the request is queued up for later activity (although in reality, the request is never acted on so that it is permanently placed in-queue) or it starts to upload blocks of the requested part so slowly that the user of the file seeking client eventually will terminate the download.

Since the block hashes from the recovery packet being used by the AICH process running on the file seeking client were sent by one of the agent clients, 103-1 to 103-N, only the corrupted blocks sent by the agent clients, 103-1 to 103-N, will be determined to be “good data” (if they ever arrive) and all blocks of the uncorrupted version of the protected content that is sent by the file sharing clients, 101-1 to 101-K, will be determined to be “bad data” and the file sharing clients having sent those blocks (i.e., their sources) will be placed on the “bad source list”.

Thus, not only does the method described in reference to FIGS. 5, 6 (and corresponding system described in reference to FIGS. 1, 5, 6) circumvent the AICH process running on the file seeking client 102 so that it may corrupt swarm downloads and freeze retransmission of corrupted parts, it further serves to take advantage of the characteristics of the AICH process to get the process to ban the file sharing clients, 101-1 to 101-K, from continued participation in downloads of the protected file for a period of time specified in the eMule protocol.

Although the various aspects of the present invention have been described with respect to a preferred embodiment, it will be understood that the invention is entitled to full protection within the full scope of the appended claims.

I claim:

1. A method for corrupting swarm downloads in a decentralized network employing advanced intelligent corruption handling, comprising:
offering copies of a corrupted version of the protected content for downloading on the decentralized network in such a manner that the copies of the corrupted version participate in swarm downloads with copies of an uncorrupted version of the protected content and sources of the copies of the corrupted version are sufficient in number so as to effectively out vote sources of the copies of the uncorrupted version in an advanced intelligent corruption handling process performed by a downloading client in the decentralized network.

2. The method according to claim 1, wherein the decentralized network employs the eMule protocol.

3. The method according to claim 1, wherein the offering of the copies of the corrupted version of the protected content comprises:
identifying the copies of the corrupted version of the protected content to the decentralized network by a file hash associated with the uncorrupted version of the protected content.

4. The method according to claim 3, wherein the offering of the copies of the corrupted version of the protected content comprises:
identifying the copies of the corrupted version of the protected content to the decentralized network by part hashes associated with the uncorrupted version of the protected content.

5. The method according to claim 1, further comprising:
providing root hashes calculated from the corrupted version of the protected content so as to discredit the sources of the copies of the uncorrupted version of the protected content in a vote conducted by the advanced intelligent corruption handling process.

6. The method according to claim 1, further comprising:
uploading a block of one of the copies of the corrupted version of the protected content in response to a request received as part of the advanced intelligent corruption handling process, wherein the uploading is performed in such a manner as to discourage a downloader of the block to complete the transmission.

7. The method according to claim 1, further comprising:
transmitting an in-queue indication in response to a request received as part of the advanced intelligent corruption handling process for a block of one of the copies of the corrupted version of the protected content.

8. The method according to claim 1, further comprising:
searching the decentralized network for clients offering copies of the protected content for downloading;
determining the number of clients offering the copies of the corrupted version of the protected content and the number of clients offering the copies of the uncorrupted version of the protected content;
calculating a percentage of the clients offering the copies of the corrupted version of the protected content relative to all clients offering copies of the corrupted and uncorrupted versions of the protected content; and
causing more clients to offer the copies of the corrupted version of the protected content if their number and percentage are less than that necessary to out vote the clients offering the copies of the uncorrupted version of the protected content in an advanced intelligent corruption handling process performed by the downloading client in the decentralized network.

9. A system for corrupting swarm downloads in a decentralized network employing advanced intelligent corruption handling, comprising:
a plurality of agent clients participating in the decentralized network by offering copies of a corrupted version of the protected content for downloading on the decentralized network in such a manner that the copies of the corrupted version participate in swarm downloads with copies of uncorrupted version of the protected content and the number of the plurality of agent clients is sufficient so as to effectively out vote, as part of an advanced intelligent corruption handling process performed by a downloading client in the decentralized network, file sharing clients offering the copies of the uncorrupted version in the decentralized network.

10. The system according to claim 9, wherein the decentralized network employs the eMule protocol.

11. The system according to claim 9, wherein the plurality of agent clients identify the copies of the corrupted version of the protected content to the decentralized network by a file hash associated with the uncorrupted version of the protected content.

12. The system according to claim 11, wherein the plurality of agent clients identify the copies of the corrupted version of the protected content to the decentralized network by part hashes associated with the uncorrupted version of the protected content.

13. The system according to claim 9, wherein the plurality of agent clients provide root hashes calculated from the corrupted version of the protected content so as to discredit file sharing clients offering the copies of the uncorrupted version of the protected content in a vote conducted by the advanced intelligent corruption handling process.

14. The system according to claim 9, wherein at least one of the plurality of agent clients uploads a block of the copy of the corrupted version of the protected content in response to a request received as part of the advanced intelligent corruption handling process from the downloading client, wherein the upload is performed in such a manner as to discourage a user of the downloading client to complete the transmission.

15. The system according to claim 9, wherein at least one of the plurality of agent clients transmits an in-queue indication in response to a request received as part of the advanced intelligent corruption handling process from the downloading client and maintains an upload responsive to the request.

16. The system according to claim 9, further comprising:
a control server configured to search the decentralized network for clients offering copies of the protected content for downloading, determine the number of agent clients offering copies of the corrupted version of the protected content and the number of file sharing clients offering copies of the uncorrupted version of the protected content, and cause more agent clients to offer copies of the corrupted version of the protected content so that in a random sample of the agent and file sharing clients, the agent clients in the random sample effectively out vote the file sharing clients in the random sample as part of an advanced intelligent corruption handling process performed by the downloading client in the decentralized network.
